(19) United States
(12) Patent Application Publication
(10) Pub. No.: US 2011/0161257 A1
(43) Pub. Date: Jun. 30, 2011

(54) METHOD, SIMULATOR ASSEMBLY, AND STORAGE DEVICE FOR INTERACTING WITH A REGRESSION MODEL

(76) Inventor: Stephen S. Bell, Easton, CT (US)

(21) Appl. No.: 12/646,989

(22) Filed: Dec. 24, 2009

(51) Int. Cl. G06N 5/02

(52) U.S. Cl. 706/11; 706/46

(57) ABSTRACT

The present invention enables a user to obtain a prediction by easily interacting with a regression model, even if the number of combinations of input variables is relatively high. The results are presented in an easy-to-read format after a relatively small amount of time for processing. Interacting with the regression model includes receiving the values of one or more input variables, determining relevant combinations of the values, finding an individual prediction for each combination, and operating on the individual predictions to produce an output variable based on the individual predictions. The invention may be embodied as a method interacting with a regression model, a simulator assembly for interacting with a regression model, or a machine readable storage medium containing instructions associated with a regression model. A common spreadsheet utility may be utilized to embody the present invention.

### BACKGROUND

A regression model can be regarded as an equation that quantifies a relationship between one or more independent variables and a dependent variable. A simple example of a regression model is provided by Hooke's law, which states that, for a spring with a fixed end and a movable end, the displacement near the equilibrium position of the movable end from its equilibrium position is proportional to the force of the spring at the movable end to restore the movable end to its equilibrium position. Hooke's law may be expressed mathematically as:

F=−kx, equation (1)

where F=the spring's restoring force;

k=a constant value, known as the “spring constant” or “force constant”; and

x=the displacement of the movable end from its equilibrium position.

When the spring constant is known, one of the displacement or the restoring force variables can easily determined if the other is known. If for example it is desired to know the restoring force associated with a given displacement, the displacement becomes the “independent variable” and the restoring force becomes the “dependent variable” of the equation above. In the present context, other terms for independent variables include “predictors,” “regressors,” and “explanatory variables,” and other terms for dependent variables include “response” and “explained variables.”

The coefficients in regression models, such as the spring constant in Hooke's law, are sometimes determined empirically (estimated) from test data, such as by least-squares curve fitting. In a hypothetical example shown in FIG. 1 (not to scale) portraying a relationship described by Hooke's law, displacement is shown as the abscissa (or “x-axis”), and the restoring force is shown as the as the ordinate (or “y-axis”). The twenty data points show the measured restoring force for a given displacement, and the dashed line is a curve fitted to the data points. This dashed line portrays the spring constant, that is, the coefficient of the regression model. An x-value is a predictor, and the corresponding y-value is the response. In other words, the regression model indicates the predicted restoring force response for a displacement predictor.

Not all regression models are expressed as simply as the linear relationship of Hooke's law. Regression models are not always in polynomial form. Regression models having more than one independent variable are known as “multiple regression models.” Many regression models involve equations that are much more elaborate than that of Hooke's law.

Regression models are widely used in industry. For example, a drug manufacturer may use a multiple regression model to predict the likelihood that a physician will prescribe a particular new drug to a patient. Such likelihood (prediction) can play a useful part in forecasting the market demand for the new drug. Independent variables may be based on the characteristics of the drug and on the characteristics of the patients. The dependent variable would be likelihood that a physician would prescribe the new drug, given a specific combination of drug and patient characteristics.

Multiple regression models such as this can include many different independent variables, for example, those relating to a patient's age, gender, and severity of symptoms to include only a few. To compound the complexity of the analyses, the user of the multiple regression models may want predictions aggregated or averaged across multiple age groups, one or both genders, and a variety of symptom severity levels.

The present inventor observed that in such situations the number of combinations of independent variables can quickly grow and the associated processing can become exceedingly burdensome. However, the inventor found no convenient way in the prior art to quickly compute predictions for such large numbers of combinations of inputs and then to conveniently and quickly display the results in a concise fashion.

The uses for regression models extend beyond the bounds of the drug industry. For example, an automobile manufacturer's forecaster may be interested in predicting market share for a new car (the dependent variable) as a function of various customer demographic variables and other customer characteristics (the predictors), for example, age, income, gender, geographic region, current type of car owned, and so on. The forecaster may be interested in an overall prediction of market share for all combinations of customer characteristics. There could easily be thousands of unique combinations of the customer characteristics. It would be highly cumbersome for the forecaster to enter each unique combination of customer characteristics into the model, one at a time, manually record the predicted market share for each of these unique combinations, and then compute an overall average.

Accordingly, a convenient way to enter numerous variations of input data and to quickly obtain an easy-to-read presentation of results would be highly useful for both intensive market research studies and for quick computations on a whim of a user interested in checking a computed value for a particular combination of predictors.

### SUMMARY

The present invention enables a user to interact with a regression model, and easily obtain a prediction, even if the number of values for the input variables, or number of unique combinations of values for multiple input variables, is high. The results are presented in an easy-to-read format after a relatively small amount of time for processing. The invention can provide a convenient tool for in-depth market research. The invention is also useful for a quick impromptu computation of a spontaneously-considered combination of values.

The invention may be embodied as a method of interacting with a regression model that produces a prediction based on one or more input variables. The method includes: contributing at least partially to receiving an indication of values of the one or more input variables such that at least one input variable has at least two possible values; contributing at least partially to determining all possible combinations of the indicated values such that each combination has a single value associated with each input variable; for each determined possible combination, contributing at least partially to using the regression model to find an individual prediction; and contributing at least partially to operating on the individual predictions to produce an output variable based on the input predictions.

In this and in other embodiments, the operating on the individual predictions may include aggregating and/or averaging the individual predictions. The output variable may be, as non-limiting examples, an aggregated prediction or an averaged prediction.

The invention may also be embodied as a simulator assembly for interacting with a regression model that produces a prediction based on one or more input variables. The simulator assembly has an input interface, a processing unit, a storage unit, and an output interface. The input interface is configured to receive signals indicating values of the one or more input variables such that at least one input variable has at least two possible values. The processing unit is operatively connected to the input interface. The storage unit is operatively connected to the processing unit and contains instructions that, when executed by the processing unit, cause the processing unit to: (1) determine all possible combinations of the indicated values of the one or more input variables such that each combination has a single value associated with each input variable; (2) for each determined possible combination, use the regression model to find an individual prediction; and (3) operate on the individual predictions to produce an output variable based on the individual predictions. The output interface is operatively connected to the processing unit, and it configured to transmit signals indicative of the output variable.

The invention may further be embodied as a simulator assembly for interacting with a regression model that produces a prediction based on one or more input variables. The simulator assembly has: an input interface means for receiving signals that indicate values of the one or more input variables such that at least one input variable has at least two possible values; a means for processing operatively connected to the input interface means; a means for storing instructions that when executed by the processing means cause the processing means to: (1) determine all possible combinations of the indicated values of the one or more input variables such that each combination has a single value associated with each input variable; (2) for each determined possible combination, use the regression model to find an individual prediction; and (3) operate on the individual predictions to produce an output variable based on the individual predictions, the means for storing being operatively connected to the means for processing; and an output interface means for transmitting signals that indicate the output variable, the output interface means being operatively connected to the processing means.

The invention may additionally be embodied as a machine readable storage medium containing instructions associated with a regression model that produces a prediction based on one or more input variables. The instructions, when executed, cause the following: receiving an indication of values of the one or more input variables such that at least one input variable has at least two possible values; determining all possible combinations of the indicated values such that each combination has a single value associated with each input variable; for each determined possible combination, using the regression model to find an individual prediction; and operating on the individual predictions to produce an output variable based on the individual predictions.

Embodiments of the present invention are described in detail below with reference to the accompanying drawings, which are briefly described as follows:

### BRIEF DESCRIPTION OF THE DRAWINGS

The invention is described below in the appended claims, which are read in view of the accompanying description including the following drawings, wherein:

FIG. 1 illustrates in graphic form a simple example of a regression model;

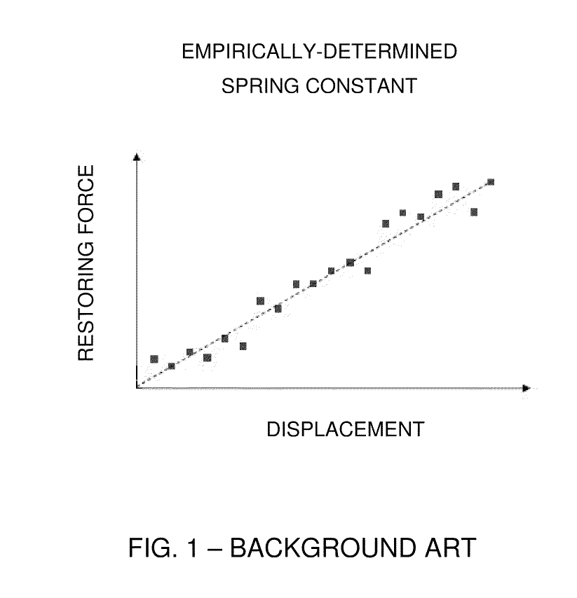

FIG. 2 provides a flow chart that represents an example of the invention embodied as a method of interacting with a regression model;

FIG. 3 provides a block diagram that represents an example of the invention embodied as a simulator assembly for interacting with a regression model;

FIG. 4 provides a block diagram that represents examples of the invention embodied as simulator assemblies for interacting with a regression model through a network;

FIG. 5a shows an image of a visual presentation of an input screen and a launch button for an example of the invention embodied as a stored file executable by a spreadsheet utility; and

FIG. 5b shows a change in the image of FIG. 5a when an input menu is pulled-down.

### DETAILED DESCRIPTION

The invention summarized above and defined by the claims below will be better understood by referring to the present detailed description of embodiments of the invention. This description is not intended to limit the scope of claims but instead to provide examples of the invention. This detailed description begins by presenting exemplary mathematics relating to a regression model. Then, the detailed description presents examples of the invention embodied as a method of interacting with a regression model, as simulator assemblies for interacting with regression models, and as a machine readable storage medium containing instructions associated with a regression model. Also described is a spreadsheet utility operated to embody the present invention.

Before describing in detail individual example embodiments of the invention, the following discussion presents exemplary mathematics involved with regression models.

The following equation is a relatively simple example of a multiple regression model:

y=exp(b₁x₁+b₂x₂)/(exp(b₁x₁+b₂x₂)+1) equation (2)

where

x₁ is the first input variable,

x₂ is the second input variable,

y is the prediction, and

b₁ and b₂ are coefficients for independent variables x₁ and x₂.

In this example, the first input variable x₁ has the possible values {1, 2 or 3}, the second input variable x₂ has the possible values {4, 5 or 6}, and the coefficients b₁, b₂ have the values {7, 8}, respectively.

If a user were to interact with the multiple regression model using the values of the input variables x₁=1 and x₂=4, the prediction y would be computed as follows:

y=exp(7(1)+8(4))/(exp(7(1)+8(4))+1) equation (3)

Because there is only one indicated value for each input variable, the number of possible combinations of input variables is one. The prediction y is relatively simple to find.

If instead the user were to interact with the multiple regression model using all possible values of the first input variable x₁ ({1, 2 and 3}) and again the value of the second input variable x₂=4, the averaged prediction y would be computed as follows:

y=[[exp(7(1)+8(4))/(exp(7(1)+8(4))+1)]+[exp(7(2)+8(4))/(exp(7(2)+8(4))+1)]+[exp(7(3)+8(4))/(exp(7(3)+8(4))+1)]/3 equation (4)

Because there are three indicated values for the first input variable and one indicated values for the second input variable, the number of possible combinations of variables is three. As shown, the sum in the equation is divided by 3 to produce the averaged prediction.

The growth in the amount of computations between the last two scenarios shown above exemplifies a change in which the total number of combinations of indicated input variables increases from one combination to three combinations in a relatively simple multiple regression model. In practice, the equations are typically much more complex, there are more than two input variables, and averaging is often desired across more than just one of the input variables. Accordingly, the first example embodiment of the invention is presented next as a convenient way to enter numerous variations of input data and to quickly obtain a prediction. Embodiments discussed later provide an easy-to-read presentation of predictions that are useful for intensive market research studies and for quick computations on a whim.

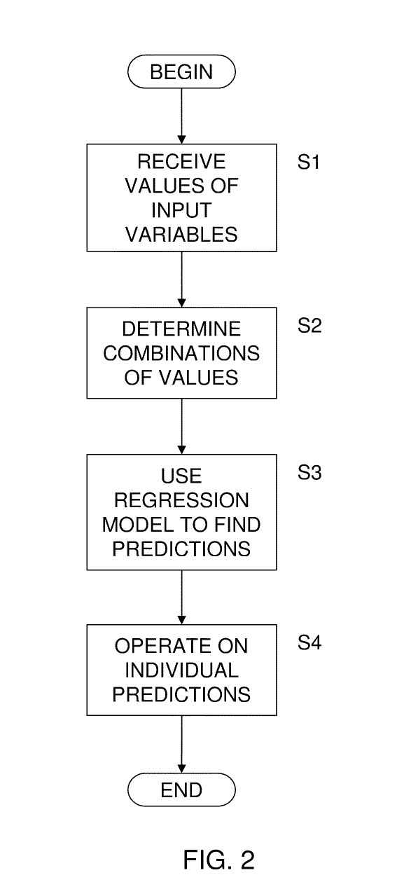

The first embodiment of the invention is described with reference the flow chart in FIG. 2. Here, the invention is embodied as a method of interacting with a regression model that produces a prediction based on one or more input variables.

The first step of this method of interacting with a regression model is to receive an indication of values of the input variables. (Step S1.) At least one of the input variables has at least two possible values. (For equation (3) above, the indicated values were {1} and {4} for the first and second input variables, respectively. For equation (4), the indicated values were {1, 2, and 3} and {4} for the first and second input variables, respectively. In only the latter scenario was there an input variable having at least two possible values.) The indication of input variables' values can be received as signals from a computer keyboard and/or a positional input device (e.g., a mouse, trackball, or touchpad) operatively connected directly to a personal computer or workstation configured to execute the method of the present embodiment. Alternatively, such signals may flow from a personal computer or workstation through a network to a server configured to execute the method. To aid in the indication of values, preset lists of available input values can be provided for the selections. For example, the present list may appear on a computer display in the form of a pull-down menu, and the user may conveniently select input values therefrom. More discussion of suitable hardware and software is provided below.

The indication of values of the input variables in Step S1 can include an indication of at least one categorical (qualitative) value. As a non-limiting example, the value of an input variable can indicate whether a patient is currently receiving old drug D1, or D2, or D3. This input variable may be part of a regression model predicting the likelihood y that the patient would receive a new drug D4, if it were to be introduced into the market. One example categorical regression model predicting the likelihood y is the following:

y=exp(b₁x₁+b₂x₂+b₃x₃)/(exp(b₁x₁+b₂x₂+b₃x₃)+1) equation (5)

where

x₁ is an indicator (“dummy”) variable for old drug D1; it is set to 0 if patient is not treated with D1, or 1 if patient is treated with D1,

x₂ is an indicator variable for old drug D2; it is set to 0 if patient is not treated with D2, or 1 if patient is treated with D2,

x₃ is an indicator variable for old drug D3; it is set to 0 if patient is not treated with D3, or 1 if patient is treated with D3,

b₁, b₂, and b₃ are coefficients for independent indicator variables x₁, x₂, and x₃, and

y is the likelihood that the patient will be treated with new drug D4.

The next step of the method of interacting with a regression model is to determine all possible combinations of the indicated values of input variable such that each combination has a single value associated with each input variable. (Step S2.) For example, for the two input variables x₁ and x₂ having possible values {x₁₁ and x₁₂} and {x₂₁, x₂₂, and x₂₃}, respectively, the possible combinations such that each combination had a single value associated with each input variable would be {x₁₁, x₂₁}, {x₁₁, x₂₂}, {x₁₁, x₂₃}, {x₁₂, x₂₁}, {x₁₂, x₂₂}, and {x₁₂, x₂₃}. If instead the possible values were {x₁₁} and {x₂₁ and x₂₂}, the possible combinations would be {x₁₁, x₂₁} and {x₁₁, x₂₂}. (For equation (3) above, the single possible combination is {1, 4}. Equation (4) has three possible combinations, {1, 4}, {2, 4}, and {3, 4}.)

After the combinations of the input variable values have been determined, the next step is to use the regression model for each determined possible combination to find the associated individual prediction. (Step 3.) Although the preceding paragraph provides examples for which there are between two and six determined possible combinations, it can readily be appreciated that in practice the number of combinations can be quite high.

The final step in this embodiment of the invention is to operate on the individual predictions that have been found using the regression model to produce an output variable based on the individual predictions. (Step 4.) For example, the operating on the individual predictions may include aggregating (totaling) the individual predictions, and the output variable would be an aggregated prediction. As another example, the operating on the individual predictions may include averaging the individual predictions, and the output variable would be an averaged prediction.

Various options exist for averaging individual predictions. For example, the individual predictions may be totaled (an intermediate aggregation) and then divided by the number of input variable combinations determined in Step 2. However, without departing from the scope and spirit of the invention, the method may be modified to process values in a repeated cycle of (1) determining an individual prediction, (2) dividing the individual prediction by the number of combinations, and (3) storing a cumulative total (aggregation) of those quotients.

Depending on the need for a particular application, the averaging of the individual predictions can be a weighted averaging, and the averaged prediction would be a weighted averaged prediction. One example way to produce a weighted average would be to associate a weight w with each value of each independent variable or with each combination of values for multiple independent variables. For instance, the preceding example may be modified to include as weights w₁, w₂, and w₃ the percentage of patients currently being treated with old drugs D1, D2, and D3, respectively. To predict the market share of new drug D4 use by all patients currently treated with drug D1 or drug D2 but not including those treated with drug D3, individual prediction y₁ and y₂ are first found as follows: For patients treated with drug D1, x₁=1, x₂=0, and x₃=0, the regression model of equation (5) above produces prediction y₁, and associated with y₁ is weight w₁. For patients treated with drug D2, x₁=0, x₂=1, and x₃=0, the regression model produces prediction y₂, and associated with y₂ is weight w₂. The weighted average can then be determined by:

(w₁y₁+w₂y₂)/(w₁+w₂) (equation 6)

In practice, the steps described hereinabove can be performed by one or more persons. Using Step 1 as an example, a single user may operate a computer keyboard and/or a positional input device operatively connected directly to a personal computer or workstation to cause the personal computer or workstation to receive an indication of values of the input variable(s). With no other persons involved in the operation, the user has “contributed wholly” to the receiving of the indication of values of the input variable(s). Such is to be contrasted with a user operating a computer keyboard and/or a positional input device (with associated personal computer or workstation) to send an indication of values of input variable(s) through a network to a server configured to execute Step 1; in this case, the user may not have contributed wholly to the receiving of the indication of values of the input variable(s). The technician that configures and maintains the server is involved, so each of the user and the technician has “contributed partially” to the receiving of the indication of values of the input variable(s). Stated differently, in both the former and latter cases for the user and in the latter case for the technician, each individually has “contributed at least partially” to the receiving of the indication of values of the input variable(s).

The individual parties contribute analogously regarding Steps 2-4, also. That is, a user operating a personal computer or workstation causing the personal computer or workstation to perform those steps, a user operating a computer keyboard and/or a positional input device (with associated personal computer or workstation) to communicate through a network to cause a server to perform those steps, and a technician that configures and maintains the server to perform those steps have each contributed at least partially to: determining all possible combinations of the indicated values of input variable(s); using the regression model to find individual predictions; and operating on the individual predictions to produce an output variable based on the individual predictions.

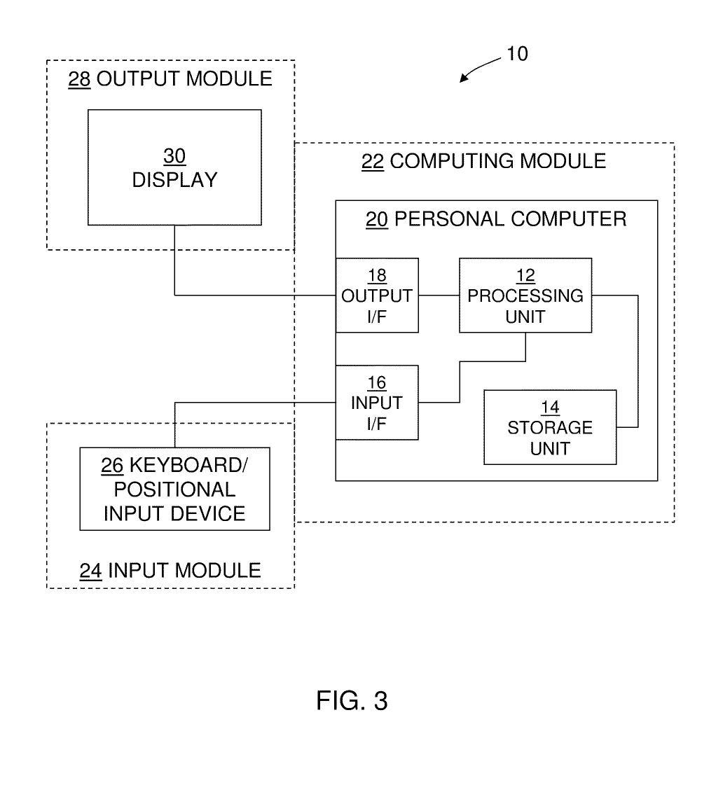

The present invention may also be embodied as a simulator assembly for interacting with a regression model that produces a prediction based on one or more input variables. Such embodiment will be discussed with reference to the block diagram in FIG. 3.

The simulator assembly 10 includes a processing unit 12, a storage unit 14, an input interface 16, and an output interface 18. In this embodiment, these components are part of a personal computer 20, and they form a computing module 22. The components instead may be part of a workstation, personal digital assistant (PDA), or smartphone as non-limiting alternative example embodiments. As a further alternative, the components may be part of a specially-designed machine built specifically for interacting with a regression model.

The input interface 16 of the simulator assembly 10 is configured to receive signals that indicate the values of the input variable(s) for the regression model. The input interface 16 may for example include a USB socket of the personal computer 20. As shown in FIG. 3, the simulator assembly 10 includes an input module 24 that is configured to transmit to the input interface 16 a user's input as the signals indicating the values of the input variable(s). For that purpose, the input module 24 includes a keyboard and/or a positional input device 26, which may connect to the personal computer 20 through the USB socket. The positional input device may be a mouse, a trackball, or a touchpad as non-limiting examples. In addition to a keyboard or positional input device, the input module 24 may include any other equivalent means for transmitting a user's input to the input interface 16.

The output interface 18 of the simulator assembly 10 is configured to transmit signals that indicate the output variable computed by the simulator assembly 10. The output interface 18 may for example include a VGA connector of the personal computer 20. As shown in FIG. 3, the simulator assembly 10 includes an output module 28 that is configured to receive the signals from the output interface 18 to indicate the output variable to the user. For that purpose, the output module 28 includes a display 30 for the user to visually observe the output variable. The display 30 may connect to the personal computer 20 through the VGA connector. In place of or in addition to the display 30, the output module may include and other equivalent means for receiving the signals from the output interface 18. For example, the use of an output device that is designed for visually-impaired users is within the scope of the invention.

As shown in FIG. 3, the processing unit 12 is operatively connected to the input interface 16, the output interface 18, and the storage unit 14. The processing unit 12 executes instructions contained in the storage unit 14. The instructions, when executed, cause the processing unit 12 to: (1) determine all possible combinations of the indicated values of the input variable(s) such that each combination has a single value associated with each input variable; (2) for each determined possible combination, use the regression model to find an individual prediction; and (3) operate on the individual predictions to produce an output variable based on the individual predictions. As non-limiting examples, the processing unit 12 may be an Intel Pentium Processor E5400, an Intel Xeon 5130 CPU, or any other equivalent means for processing (executing) instructions contained in the storage unit 14. Also as non-limiting examples, the storage unit 14 may be SATA hard drive, a flash memory SSD, or any other equivalent means for storing instructions that when executed by the processing unit 12 cause the processing unit 12 to function as described above. The storage unit 14 may be an external USB flash drive.

The user of the simulator assembly 10 may indicate the values of the input variable(s) by selecting from preset lists of available values that are visually observable on the display 30. For example, the preset lists may take a form resembling pull-down menus of a Microsoft® Windows-based utility, as discussed in more detail below. The simulator assembly 10 can be configured so that indicating the values of the input variable(s) allows for indicating categorical values.

Also, the simulator assembly 10 can be configured so that the operating on the individual predictions includes aggregating the individual predictions, and the output variable would be an aggregated prediction. The simulator assembly 10 can be configured so that the operating on the individual predictions includes averaging the individual predictions, and the output variable would be an averaged prediction. Further, the simulator assembly 10 can be configured so that the averaging of the individual predictions is a weighted averaging, and the averaged prediction would be a weighted average prediction.

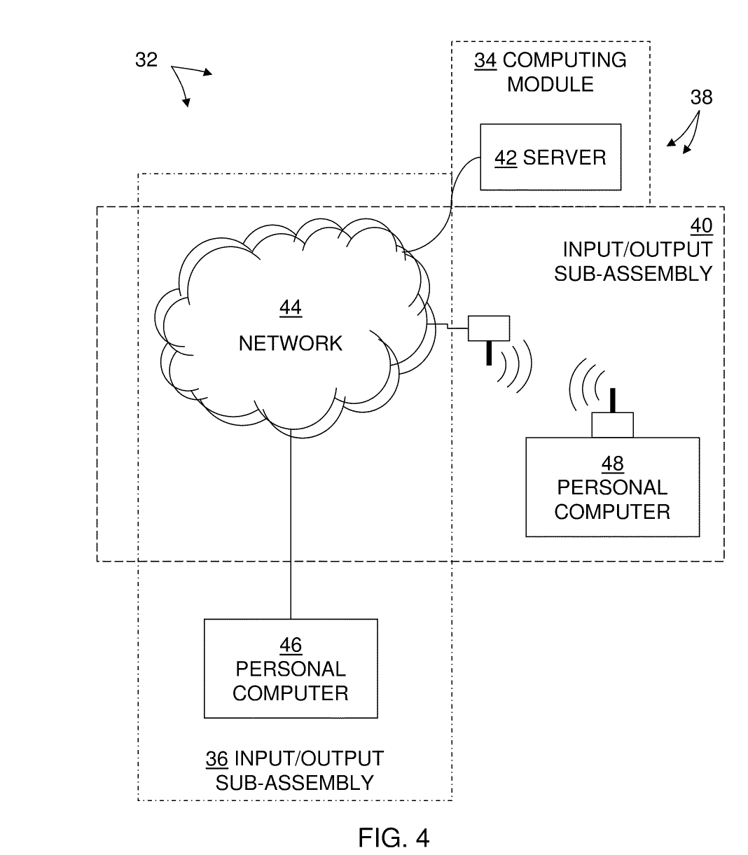

The embodiment of FIG. 3 may be modified to allow a user to interact with a regression model through a network. As non-limiting examples, the network may be a local area network (LAN) within an office environment or alternatively the Internet. Thus, a user may interact using a Microsoft® Windows-based utility or a web browser, also non-limiting examples. Examples of such modified simulator assemblies are shown with reference to the block diagram in FIG. 4.

One simulator assembly 32 of FIG. 4 includes a computing module 34 and an input/output sub-assembly 36, and another simulator assembly 38 includes the computing module 34 and an input/output sub-assembly 40. The computing module 34 of FIG. 4 is analogous to the computing module 22 of FIG. 3, with the differences being apparent from the discussion herein. For example, the personal computer 20 of FIG. 3 is replaced by a server 42, although the relevant internal components are basically or very nearly the same. Also, instead of using USB sockets or VGA connectors as the input interface 16 and the output interface 18, respectively, the server 42 may use 8P8C modular Ethernet sockets (sometimes referred to as “RJ45” sockets) for both input and output interfaces to a network 44. As is apparent for the embodiments of both FIGS. 3 and 4, the input interface 16 can be a USB socket, an 8P8C modular Ethernet socket, or any other equivalent means for receiving signals that indicate values of the input variable(s). Also, the output interface 18 can be a VGA connector, an 8P8C modular Ethernet connector, or any other equivalent means for transmitting signals that indicate the output variable.

As shown in FIG. 4, the network 44 is part of both the input/output sub-assembly 36 and the input/output sub-assembly 40. Both input/output sub-assemblies 36, 40 are configured to transmit through the network 44 to the input interface of the server 42 user inputs as the signals indicating the values of the input variable(s). Both input/output sub-assemblies 36, 40 are also configured to receive signals from the output interface of the server 42 through the network to indicate the output variable to the user. Users may interact with the server 42 using a personal computer 46 of the simulator assembly 32 or using a personal computer 48 of the simulator assembly 38. The personal computer 46 communicates with the network 44 via a wired connection, and the personal computer 48 communicates with the network 44 via a wireless connection. Besides input/output subassemblies 36, 40 using personal computers with wired and wireless connections to the network 44, the input/output subassembly can instead be any other equivalent means for transmitting/receiving signals through/from the network 44.

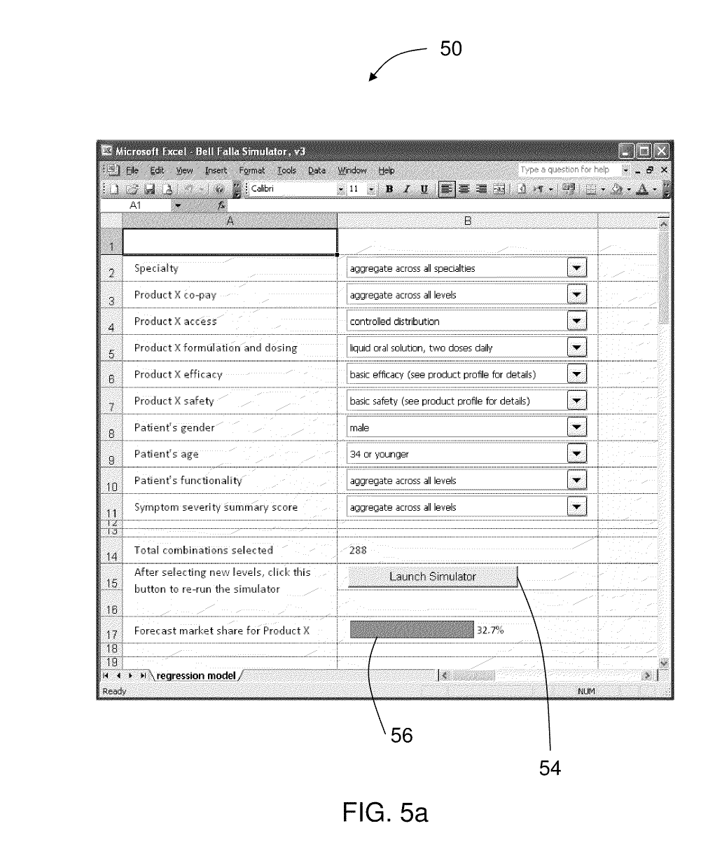

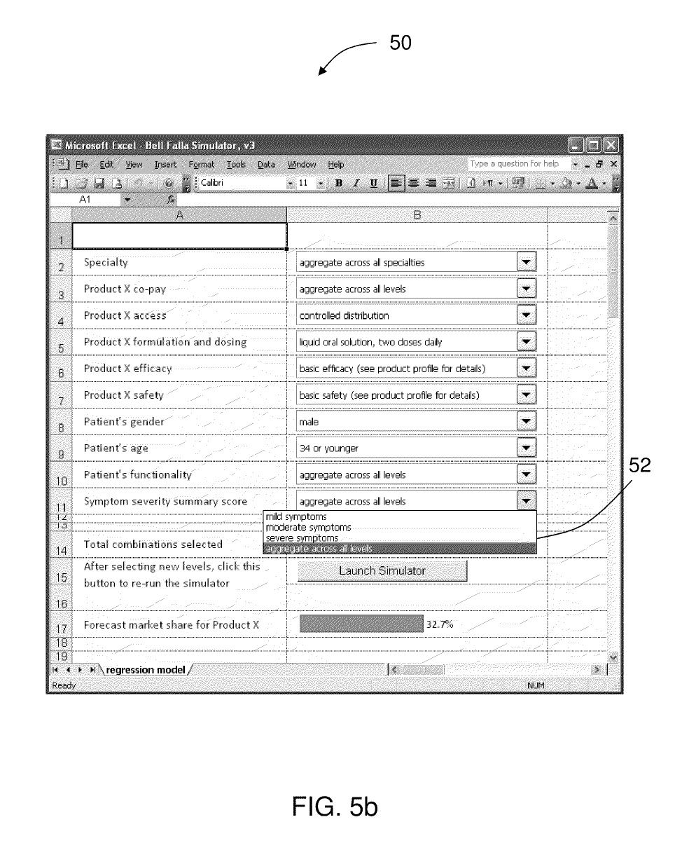

In another embodiment of the invention, a file stored on a machine readable storage medium is executed by a spreadsheet utility, for example, Microsoft® Excel 2003, as shown in FIGS. 5a and 5b. As shown in the figures, a display pane 50 includes columns A and B and rows 1-19. Column A presents the labels for ten different input variables, and column B provides 10 corresponding pull-down menus for the user to indicate the values of the input variables. In FIG. 5b, the menu 52 for the categorical values “Symptom severity summary score” is pulled down to show the choices “mild symptoms,” “moderate symptoms,” “severe symptoms,” “aggregate across all levels”. After the user has indicated all the values of the input variables, a positional input device is used to press the “Launch Simulator” button 54, and the prediction “Forecast market share for Product X” is promptly computed and clearly displayed as 32.7% (hypothetical computation). In this embodiment, a bar graph 56 appears next to the prediction's value to show the prediction in an additional visual format.

The file containing the instructions may be stored on a personal computer or server hard drive, a CD, a USB flash drive, or any other similar machine readable storage medium. Accordingly, the storage medium contains instructions associated with a regression model. The instructions, when executed, cause: (1) the receipt of an indication of values of one or more input variables; (2) the determination of all possible combinations of the indicated values such that each combination has a single value associated with each input variable; (3) for each determined possible combination, the use of the regression model to find an individual prediction; and (4) the operating on the individual predictions to produce an output variable based on the individual predictions.

Having thus described exemplary embodiments of the invention, it will be apparent that various alterations, modifications, and improvements will readily occur to those skilled in the art. Alternations, modifications, and improvements of the disclosed invention, though not expressly described above, are nonetheless intended and implied to be within spirit and scope of the invention. Accordingly, the foregoing discussion is intended to be illustrative only; the invention is limited and defined only by the following claims and equivalents thereto.

I claim:

1. A method of interacting with a regression model that produces a prediction based on one or more input variables, the method comprising:
contributing at least partially to receiving an indication of values of the one or more input variables such that at least one input variable has at least two possible values;
contributing at least partially to determining all possible combinations of the indicated values such that each combination has a single value associated with each input variable;
for each determined possible combination, contributing at least partially to using the regression model to find an individual prediction; and
contributing at least partially to operating on the individual predictions to produce an output variable based on the individual predictions.

2. The method of claim 1, wherein the receiving of the indication of values of the one or more input variables includes receiving signals through a network, the signals being indicative of the values.

3. The method of claim 1, wherein the indication of values of the one or more input variables is effected by selecting the values from preset lists of available input values.

4. The method of claim 1, wherein the indication of values of the one or more input variables includes an indication of at least one categorical value.

5. The method of claim 1, wherein the operating on the individual predictions includes aggregating the individual predictions, and wherein the output variable is an aggregated prediction.

6. The method of claim 1, wherein the operating on the individual predictions includes averaging the individual predictions, and wherein the output variable is an averaged prediction.

7. The method of claim 6, wherein the averaging of the individual predictions is a weighted averaging, and wherein the averaged prediction is a weighted averaged prediction.

8. A machine readable storage medium containing instructions associated with a regression model that produces a prediction based on one or more input variables, the instructions when executed causing the following:
receiving an indication of values of the one or more input variables such that at least one input variable has at least two possible values;
determining all possible combinations of the indicated values such that each combination has a single value associated with each input variable;
for each determined possible combination, using the regression model to find an individual prediction; and
operating on the individual predictions to produce an output variable based on the individual predictions.

9. The machine readable storage medium of claim 8, wherein the indication of values of the one or more input variables is effected by selecting the values from preset lists of available input values.

10. The machine readable storage medium of claim 8, wherein the indication of values of the input values includes an indication of at least one categorical value.

11. The machine readable storage medium of claim 8, wherein the operating on the individual predictions includes aggregating the individual predictions, and wherein the output variable is an aggregated prediction.

12. The machine readable storage medium of claim 8, wherein the operating on the individual predictions includes averaging the individual predictions, and wherein the output variable is an averaged prediction.

13. The machine readable storage medium of claim 12, wherein the averaging of the individual predictions is a weighted averaging, and wherein the averaged prediction is a weighted average prediction.

14. A simulator assembly for interacting with a regression model that produces a prediction based on one or more input variables, the simulator assembly comprising:
an input interface configured to receive signals indicating values of the one or more input variables such that at least one input variable has at least two possible values;
a processing unit operatively connected to the input interface;
a storage unit operatively connected to the processing unit and containing instructions that when executed by the processing unit cause the processing unit to: (1) determine all possible combinations of the indicated values of the one or more input variables such that each combination has a single value associated with each input variable; (2) for each determined possible combination, use the regression model to find an individual prediction; and (3) operate on the individual predictions to produce an output variable based on the individual predictions; and
an output interface operatively connected to the processing unit, the output interface configured to transmit signals indicative of the output variable.

15. The simulator assembly of claim 14 further comprising:
an input module configured to transmit to the input interface a user's input as the signals indicating the values of the one or more input variables; and
an output module configured to receive the signals from the output interface to indicate the output variable to the user.

16. The simulator assembly of claim 15, wherein the input module includes a keyboard and a positional input device.

17. The simulator assembly of claim 15, wherein the output module includes a display for the user to visually observe the output variable.

18. The simulator assembly of claim 14 further comprising:
an input/output sub-assembly that includes a network;
wherein the input/output sub-assembly is configured to transmit to the input interface a user's input as the signals indicating the values of the one or more input variables, the transmission being through the network; and
wherein the input/output sub-assembly is also configured to receive signals from the output interface through the network to indicate the output variable to the user.

19. The simulator assembly of claim 14, wherein the indicating of values of the one or more input variables is effected by selecting the values from preset lists of available input values, the preset lists being visually observable on a display.

20. The simulator assembly of claim 14, wherein the indicating of values of the one or more input variables includes indicating at least one categorical value.

21. The simulator assembly of claim 14, wherein the operating on the individual predictions includes aggregating the individual predictions, and wherein the output variable is an aggregated prediction.

22. The simulator assembly of claim 14, wherein the operating on the individual predictions includes averaging the individual predictions, and wherein the output variable is an averaged prediction.

23. The simulator assembly of claim 22, wherein the averaging of the individual predictions is a weighted averaging, and wherein the averaged prediction is a weighted average prediction.

24. A simulator assembly for interacting with a regression model that produces a prediction based on one or more input variables, the simulator assembly comprising:
an input interface means for receiving signals that indicate values of the one or more input variables such that at least one input variable has at least two possible values;
a means for processing operatively connected to the input interface means;
a means for storing instructions that when executed by the processing means cause the processing means to: (1) determine all possible combinations of the indicated values of the one or more input variables such that each combination has a single value associated with each input variable; (2) for each determined possible combination, use the regression model to find an individual prediction; and (3) operate on the individual predictions to produce an output variable based on the individual predictions, the means for storing being operatively connected to the means for processing; and
an output interface means for transmitting signals that indicate the output variable, the output interface means being operatively connected to the processing means.

25. The simulator assembly of claim 24 further comprising:
a means for transmitting to the input interface means a user's input as the signals that indicate the values of the one or more input variables; and
a means for receiving the signals from the output interface means to indicate the output variable to the user.

26. The simulator assembly of claim 24 further comprising:
an input/output means for: (1) transmitting through a network to the input interface means a user's input as the signals that indicate the values of the one or more input variables; and (2) receiving the signals through the network from the output interface means to indicate the output variable to the user.
